(19) United States
(12) Patent Application Publication
(10) Pub. No.: US 2024/0342977 A1
(43) Pub. Date: Oct. 17, 2024

(54) Floor plank modification system

(71) Applicant: NewGen Enterprises, LLC, Boynton Beach, FL (US)

(72) Inventors: Carlos Mendez, Miami, FL (US); Joel Ruiz, Miramar, FL (US)

(21) Appl. No.: 18/634,385

(22) Filed: Apr. 12, 2024

Related U.S. Application Data
(60) Provisional application No. 63/496,187, filed on Apr. 14, 2023.

(51) Int. Cl. B29C 59/04; B29C 59/00; B29L 31/00; B65B 35/48; B65B 35/50

(52) U.S. Cl. CPC B29C 59/046; B29C 59/002; B65B 35/48; B65B 35/50; B29K 2875/00; B29L 2031/732

(57) ABSTRACT

A production line system and apparatus that applies heat and pressure to plastic composite floorings to fold into stair noses. The production line is made of independent modules that are interconnected, namely automatic plank loader; motorized heating station; rotary positive and negative embossing; motorized cooling station; an unloading station for workpiece nesting and an unloading station for pallet stacking.

### PRIORITY CLAIM

In accordance with 37 C.F.R. 1.76, a claim of priority is included in an Application Data Sheet filed concurrently herewith. Accordingly, the present invention claims priority to U.S. Provisional Patent Application No. 63/496, 187, entitled “FLOOR PLANK MODIFICATION SYSTEM”, filed Apr. 14, 2023. The contents of the above referenced application are incorporated herein by reference in its entirety.

### FIELD OF THE INVENTION

The present invention relates to the modification of plastic composite flooring and in particular to a high-volume modification system that applies heat and pressure to plastic composite floorings to fold into stair noses and other trim flooring elements to complete the aesthetics of an installation.

### BACKGROUND OF THE INVENTION

Installation of flooring requires an installer to adapt to the particular substrate that shapes a flooring installation. These substrates may include floor, wall or room transitions. Typically, an installer must accommodate various provisions namely stair noses, end caps, T-moulding or threshold. Stair noses are provisions that are installed at the edge of stair treads above and at the edge of the flooring. End-caps are provisions to be installed at the end of the flooring installation to cover the top and side edge. T-Moulding is used to transition one flooring type to another of equal height or to gain expansion spaces. Threshold is used to provide a smooth and safe transition between flooring surfaces of unequal heights.

The above pieces are installed separate from the flooring which can cause a mismatch. For instance, the stair nose may not match the visual of the rest of the flooring material, or the estimator may have under/over ordered such pieces, adding to the burden of the installation. Most trim pieces are of standard shape so they may not match the dimension of the substrate. As an example, in many instances the trim pieces may be constructed of a different material such as solid milled wood, plastic, or reformed wood which can lead to different textures, visual appearance, wear patterns, and ultimately a dissatisfied consumer. It is desired at times to provide a seamless transition from the floor to the wall junction and from room to room in larger house, which is not possible with conventional flooring.

One of the latest trends in home flooring design is a rigid core flooring. Many homeowners are choosing this stylish and affordable option to give their home a new look. There are two main types of rigid core flooring: stone plastic composite and wood plastic composite. A stone plastic composite (SPC) vinyl and wood plastic composite (WPC) vinyl flooring is manufactured with a wood-plastic composite backing instead of a solid PVC backing. The backing combines recycled wood pulp and plastic composites to form a bond of strength and stability. It is then topped with a standard vinyl top layer.

The basics about stone plastic composite (SPC) vinyl flooring and wood plastic composite (WPC) vinyl flooring is it is constructed of layers, which helps with ease of installation and provides superior comfort and stain resistance. Generally, there are four layers. The top “wear” layer which protects and guards against scratches, dents, stains, and general wear and tear. The second printed vinyl layer lies just below the wear layer. This layer has imprinted designs and colors. Under the second layer is an extruded waterproof core, which is the biggest benefit of SPC and WPC flooring as it will not buckle, ripple, or shows any other sign of liquid damage due to moisture. This core also enables the strength of a “click-system” which accelerates installation and makes floor imperfections more forgiving at installation, avoiding extra floor preparation. The final layer contains a padded underlayment making which further helps with substrate imperfections and provides comfort under foot and superior sound proofing than other products. Rigid core as used herein is identified as WPC, SPC, or densified foam core.

There are a variety of benefits associated with SPC and WPC flooring. They both have a completely waterproof core, thereby helping to prevent warping when exposed to moisture. Additionally, their waterproof property allows for this type of flooring to be used in areas of the home where hard flooring and other moisture-sensitive flooring types are not typically recommended, such as laundry rooms, bathrooms, and kitchens. They also both are resistant to scratches and stains as well as resistant to major impacts due to their density. Generally, SPC and WPC flooring comes in thickness of 2.5 mm to 12 mm. A thicker flooring option can make up for slight flaws in subfloor defections. They hold up well to wear and tear even in high-traffic areas of the home. They are also easy to install, making them a good choice for “DIY” homeowners. They are made to be installed on top of about any type of subfloor or existing floor, and do not require adhesives. Lastly, there is a large variety of stylish options as they come in about any color and pattern, since the design is simply printed onto the vinyl layer. For example, one can get WPC or SPC flooring that looks like tile, stone, or hardwood flooring.

One beneficial aspect of SPC and WPC flooring is its ability to conform. The present invention discloses a production system of applying heat and pressure to a plastic composite flooring system to fold such into stair noses or other trim elements.

U.S. Pat. No. 8,561,369 illustrates a molding profile having interlocking profiles to transition from a first flooring surface to a second flooring surface.

U.S. Pat. No. 8,590,266 discloses a machine and method for installing curved hardwood flooring. The machine maintains the wood grain in the direction of any bends required to conform to a curved structure. The method has a first step to establish the desired floor boundary and anchor a plurality of pressure units in place at appropriate intervals to accurately represent the desired shape of the curved hardwood floor to be installed. A second step is to make appropriate adjustments to the pressure units and position the hardwood flooring in the machine and a third step is to activate the pressure units to bend the flooring into the desired contour; hold securely; make adjustments, if necessary and nail the hardwood flooring to the sub-floor. Then repeat steps 2 and 3 until the hardwood floor is completed.

U.S. Patent Publication No. 2006/0032175 discloses a method of making flooring products. Disclosed is a polymeric thermoplastic material plank that can be rectangular, triangular, square, hexagonal, and octagonal or have any number of sides. Also, the floor panel can have other geometrical designs, such as curves.

U.S. Pat. No. 10,138,639 illustrates a molding assembly of use in bridging a gap between floor covering materials.

Applicant's U.S. Pat. No. 11,485,166 is directed to a method of folding plastic composition flooring to form a desired shape at the point of use, the contents of which is incorporated herein by reference.

There is a need for an apparatus capable of high volume shaping of folding plastic composition flooring into a stair nose.

### SUMMARY OF THE INVENTION

Disclosed is a production line system and apparatus that applies heat and pressure to plastic composite floorings to fold into stair noses and other trim elements. The system is designed for high volume production of stair noses and other trim elements. As an example the system can produce 5,000 units per 8-hour shift, using a 6 mm-thick SPC floor in a 7×48 inch format. The production line is capable of producing 2 pieces every 10 seconds. The production line is made of 6 independent module that are interconnected, namely 1) automatic plank loader; 2) motorized heating station; 3) rotary positive and negative embossing; 4) motorized cooling station; 5) unloading station (A) and 6) unloading station (B). Production speeds will vary with WPC/SPC dimensions and machines heat zone and cooling section length.

The production method includes the step of applying heat and pressure to a plastic composite flooring system to fold into stair noses and other trim elements. The method includes incorporating a thermal insulation layer between the plastic composite flooring and a heat generator, applying heat until reaching a heat transmission coefficient to allow the plastic composite flooring to become malleable, removing the heat, applying pressure to the heated section of the plastic composite flooring through a plurality of rollers to form into a desired shape using a positive and negative embossing die fold on the top and bottom heated section of the plastic composite flooring, and stacking the shaped pieces through nesting.

Accordingly, it is an objective of the instant invention to provide a high-volume modification system that applies heat and pressure to plastic composite floorings to fold into stair noses and other trim elements.

It is another objective of the instant invention to provide a high-volume modification system to facilitate the installation of LVP, LVT, SPC, and WPC flooring to create seamless transitions in stair noses.

It is also an objective of the instant invention to provide a high volume modification system that includes an automatic plank loader; a motorized heating station; rotary positive and negative embossing; motorized cooling station; a first unloading station for nesting of work pieces, and second unloading station for stacking of work pieces.

It still another objective of the instant invention to provide a predetermined gap space within the thermal insulation layer to allow for proper heat transfer from the heat generator to the plastic composite flooring.

Other objectives and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE DRAWINGS

FIG. 1 is a perspective view of the SPC stair nose production line of the instant invention;

FIG. 2 is a perspective view of the production line;

FIG. 3 is a foot print of the production line;

FIG. 4A is a perspective view of the plank loader;

FIG. 4B is a top plane view of the plank loader;

FIG. 5A is a top plane view of the motorized heating station;

FIG. 5B is a perspective view of the motorized heating station;

FIG. 5C is a perspective view of the motorized heating station with top covers in various states of opening;

FIG. 6A is a diagram of positive and negative embossing steps;

FIG. 6B is a perspective view of the positive and negative embossing steps;

FIG. 6C is a top view of the positive and negative embossing module;

FIG. 6D is a left upper perspective view of the positive and negative embossing module with hand wheel adjustment;

FIG. 6E is a perspective view of the workpiece from flat to fully formed;

FIG. 6F is a perspective view of positive and negative embossing rollers;

FIG. 7A is a top view of the motorized cooling station;

FIG. 7B is an upper perspective view of the motorized cooling station;

FIG. 7C is a partial upper perspective view of the motorized cooling station illustrating the ventilation slits;

FIG. 7D is an upper perspective view of the motorized cooling station illustrating work piece positioning;

FIG. 7E is an upper right perspective view of the rollers forming a work piece in the motorized cooling station;

FIG. 7F is an upper left perspective view of the rollers forming a work piece in the motorized cooling station;

FIG. 7G is a right perspective view of the rollers forming a work piece in the motorized cooling station;

FIG. 8A is a top view of a first unloading station;

FIG. 8B is a diagram illustrating workpiece positions on the first unloading station;

FIG. 8C is a perspective view of the first unloading station;

FIG. 9A is a top view of the second unloading station;

FIG. 9B is a cross sectional side view of the second unloading station;

FIG. 9C is a perspective upper view of the second unloading station carrying work pieces;

FIG. 9D is an end view of the second unloading station carrying work pieces;

FIG. 10A is a perspective upper view of a pallet layout; and

FIG. 10B is an end view of the pallet layout.

### DETAILED DESCRIPTION OF THE PREFERRED EMBODIMENT

Detailed embodiments of the instant invention are disclosed herein; however, it is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the art to variously employ the present invention in virtually any appropriately detailed structure.

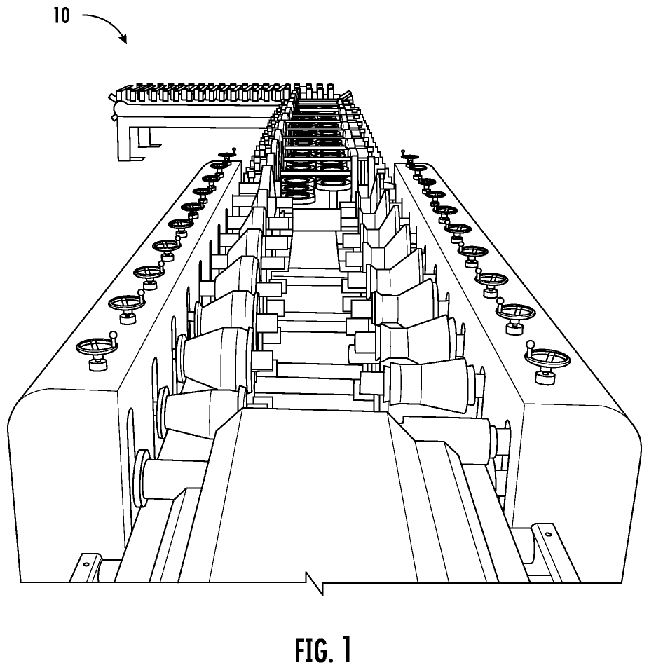

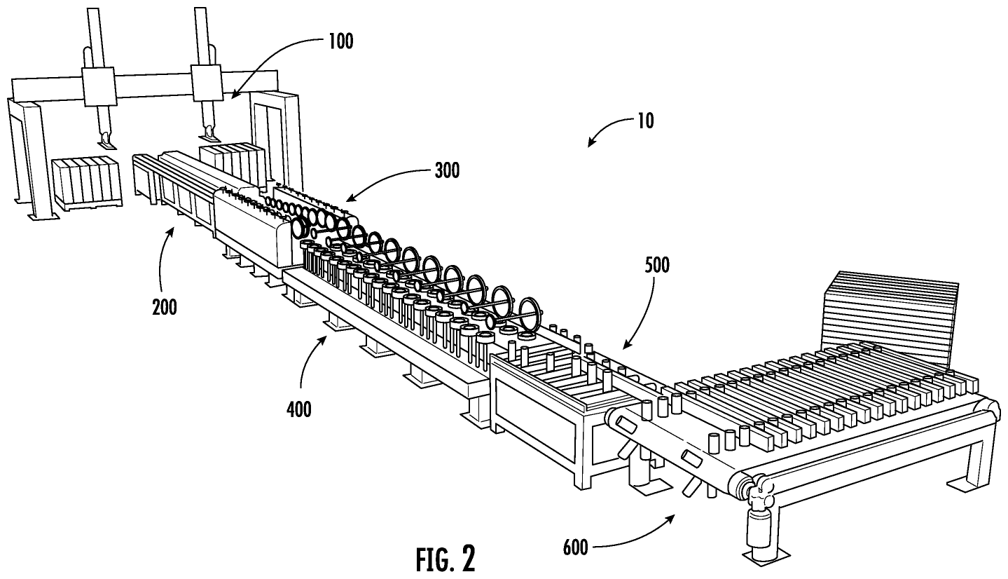

Referring to the Figures in general and in particular FIGS. 1-3, the disclosed production line 10 is designed for a production requirement of 5,000 units per 8-hour shift, using a 6 mm-thick SPC floor in a 7×48 inch format. FIG. 1 is a perspective view of the SPC stair nose production line 10 of the instant invention, FIG. 2 is a perspective view of the production line 10, and FIG. 3 is a foot print of the production line 10. The production line 10 is made of 6 independent module that are interconnected. The production line 10 is capable of producing 2 pieces every 10 seconds. The production line 10 is made of 6 independent module that are interconnected, namely 1 automatic plank loader 100; 2) motorized heating station 200; 3) rotary positive and negative embossing 300; 4) motorized cooling station 400; 5) unloading station (A) 500 and 6) unloading station (B) 600.

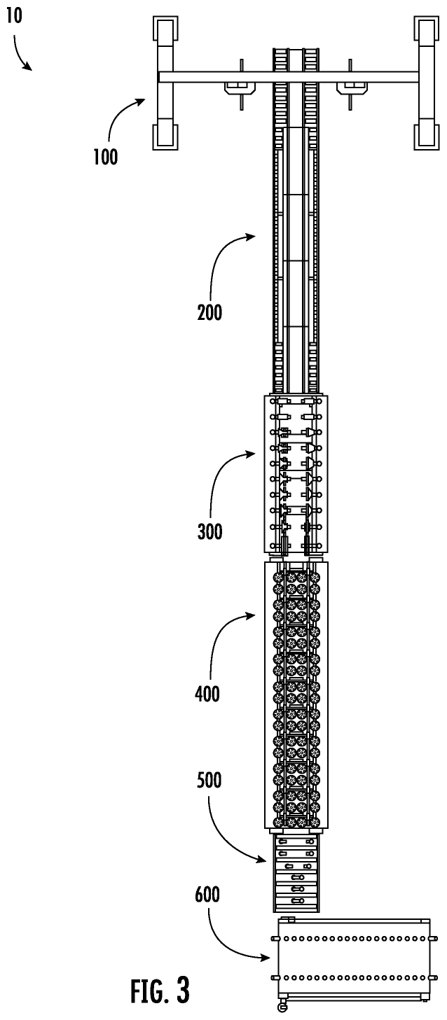

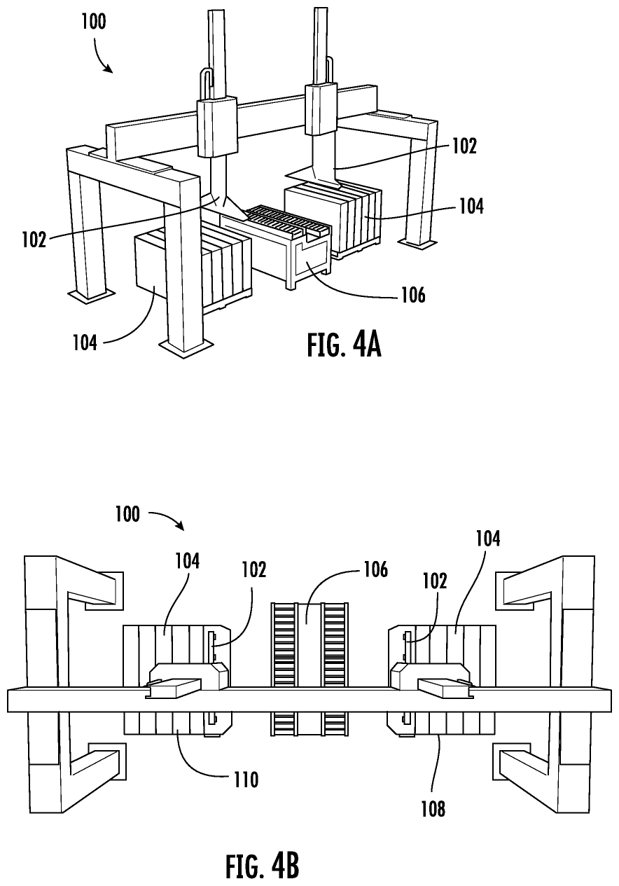

Referring to FIGS. 4A-4B, illustrated is an automatic plank loader 100 employs pneumatic suction cups 102 to hold the sheets 104 from both sides independently and place them in the motorized feeder 106. Planks, or workpieces 12, from both sides are placed on the feeder 106 at the same time so they can be manufactured simultaneously. The individual workpieces 12 are placed on a first side pallet 108 on the right with the printed part of the floor facing up and a second side pallet 110 on the left with the print facing down. This is important because later in the production line 10 two workpieces 12 will be manufactured simultaneously in opposite positions to optimize the unloading process from the machine and subsequent palletization.

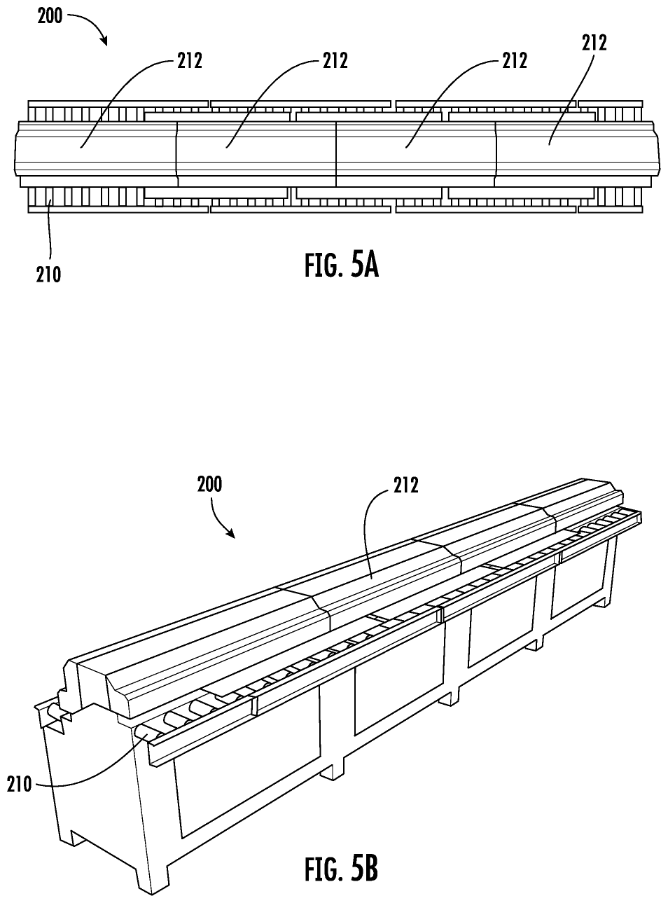

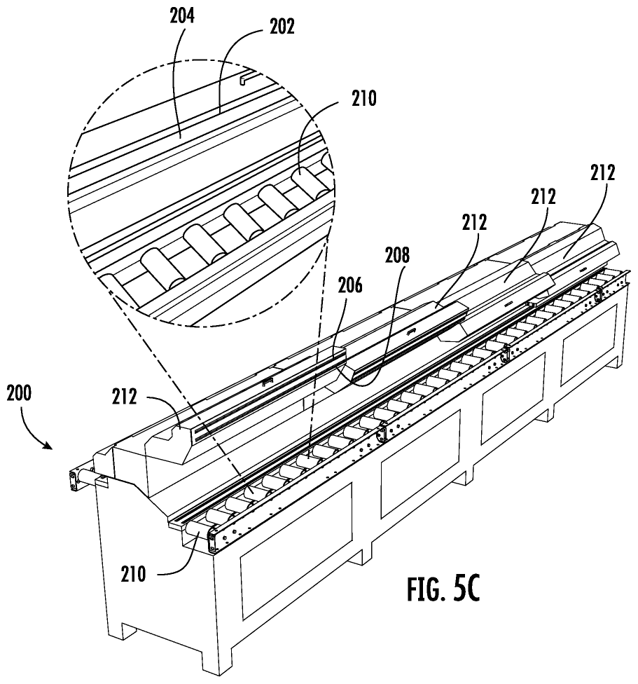

Referring to FIGS. 5A-5C, disclosed is the motorized heating station 200 used to reach a correct temperature to make the workpiece 12 malleable for forming into the desired shape. This section consists of two continuous heating source lines 202 separated by thermal insulation 204 to concentrate the heat where the workpiece 12 is going to be bent. This section consists of two continuous heating source lines 202 separated by thermal insulation 204 to concentrate the heat where the workpiece is going to be bent in accordance with the teaching of U.S. Pat. No. 11,485,166, the contents of which are incorporated herein by reference. This section has an upper heat source 206 and a lower heating source 208 to speed up the heating process.

Motorized rollers 210 preferably feed the workpieces 12 at a rate of approximately 25 feet per minute. For example, a four foot board can be made within 40 seconds from entering the machine to the end of the module. The upper heat source 206 is divided into four independent sections on each side and can be accessed by opening the top covers 212 for maintenance and repair. The advance speed of the roller 210 must be higher or lower depending on the density of the material, when the plank leaves this module it must be on both sides at approximately 200 degrees F. (about 93 degrees C.) where it is going to be folded. In the preferred embodiment, the heating source temperature is 600 F (about 315 C), and the heating source diameter is ⅝ inches (about 16 mm).

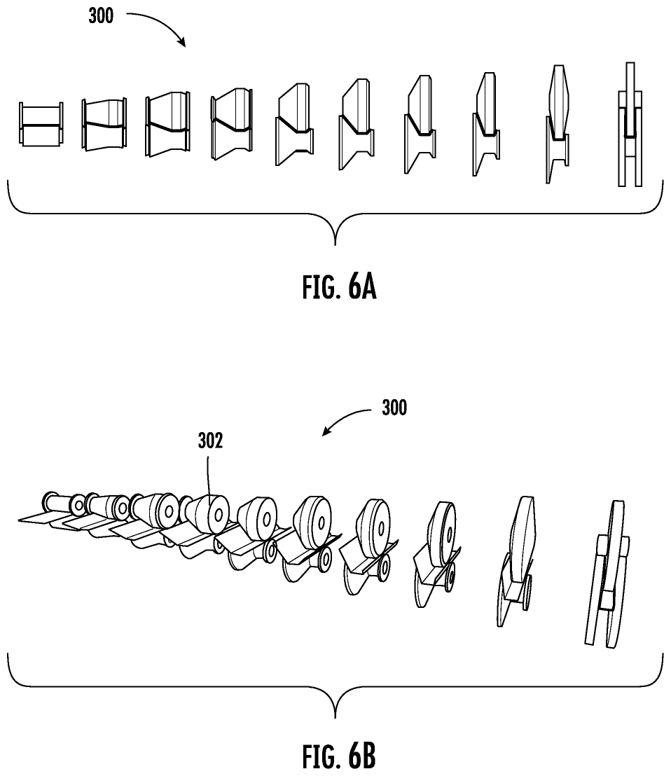

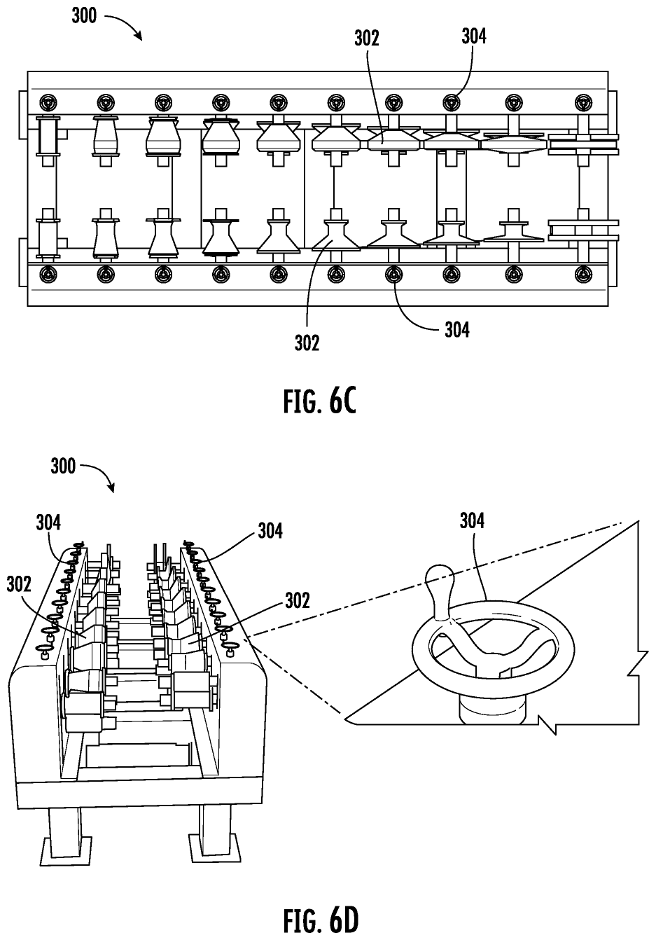

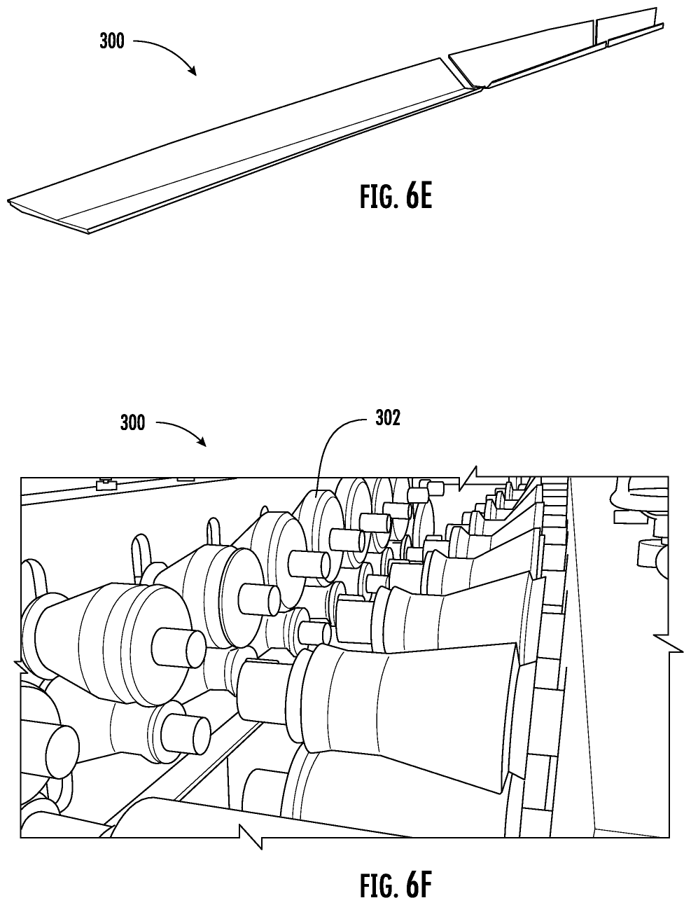

Referring to FIGS. 6A-6F, illustrated is the rotary positive and negative embossing 300 constructed and arranged to keep the board or workpiece moving while the workpiece is gradually formed right out of the heating station 200. This molding process is performed in 10 gradual steps. In the last step, the part is fully formed. In this process, two parts are produced simultaneously, one on each side of the machine in opposite positions. Step 1 illustrates the workpiece in a substantially flat configuration and through the steps the workpiece 12 remains heated as each set of rotating positive and negative embossing dies mature the workpiece 12 until a final configuration is achieved, as illustrated by Step 10. In step number 10, the workpiece is fully formed, however, since the piece springs back when it comes out of the mold, the angles are a little more close than desired. Spring back is the elastic deformation that appears after shaping and is compensated with the overbending of the piece.

The rotary positive and negative embossing 300 stage includes rollers 302 incorporated into each Step of the process. In a preferred embodiment, the rollers 302 are made of polyurethane material. Each workpiece is precisely formed into the desired shape by pressure exerted onto the workpiece 12 by different sized rollers 302. A laborer may adjust the pressure of the rollers 302 independently by turning a handwheel 304 associated with the corresponding roller 302. The adjustment of the pressure is critical to obtain the desired result.

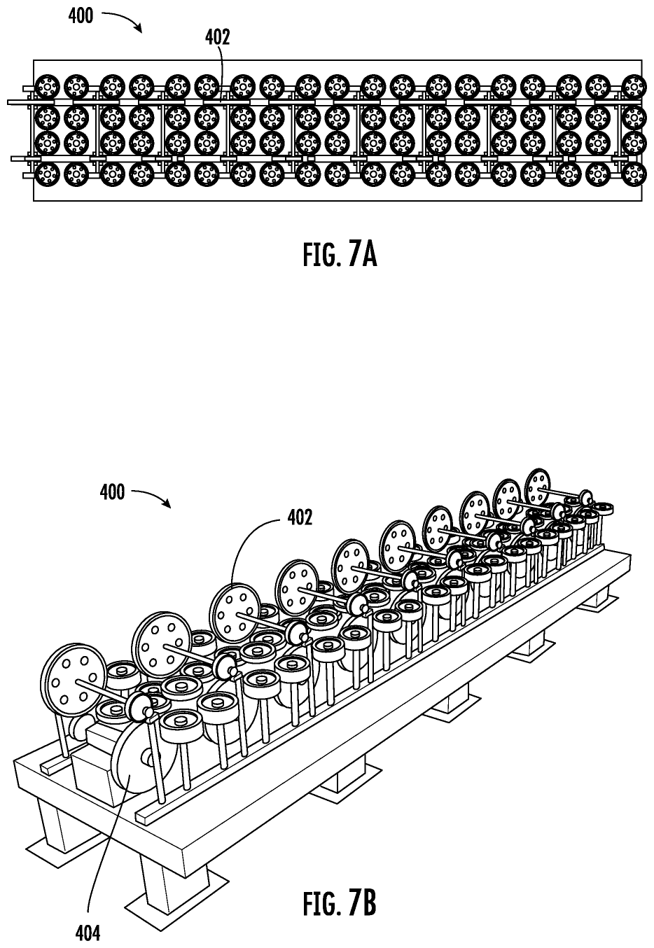

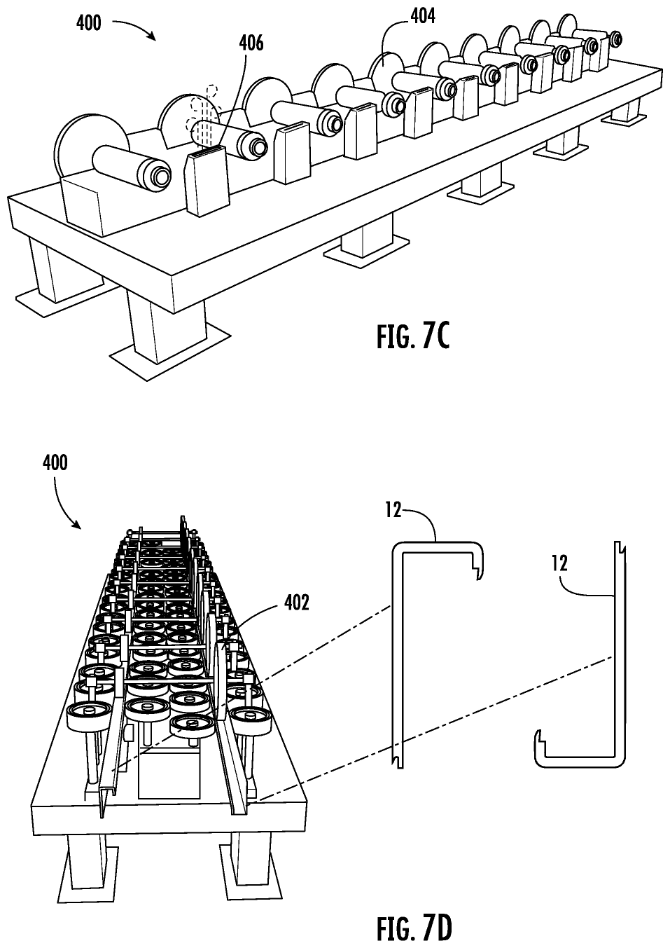

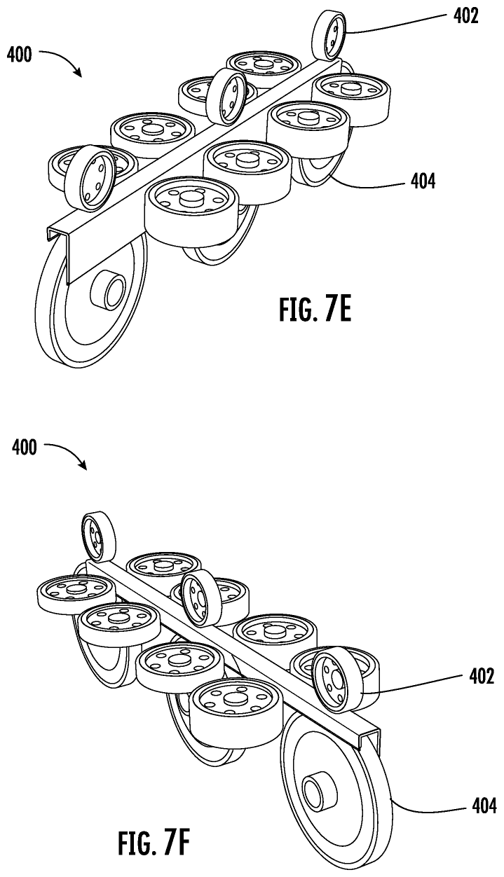

Referring to FIGS. 7A-7G, illustrated is the motorized cooling station 400 for use in cooling the workpieces 12 as they are expelled from the rotary positive and negative embossing module 300. The workpieces 12 remain hot and malleable directly after being formed. The cooling station 400 employs a system of upper rollers 402 and lower rollers 404 to keep the workpieces 12 in the correct shape while a system of fans blows fresh air so that the work pieces cool into the desired shape. In this module, the adjustment of rollers 402 is important to address the spring back of the workpieces 12 as they cool. The spring back of the molds must be compensated so that the workpiece 12 leaving this section has the required bending angles. In a preferred embodiment, the motorized rollers 402 feed the workpieces at 25feet per minute which makes a four-foot plank take 40 seconds from entering the machine to the end of this module. The upper rollers 402 are adjustable and free spinning. With these rollers, each piece must be maintained at the exact angles required. The lower rollers 404 are motorized and used to make the workpiece 12 travel at the required speed. Referring to FIG. 7C, eighteen vents 406 are used to draw cool air from under the workpiece to help dissipate heat and keep the part cool and retain its molded shape. FIG. 7D illustrates two full formed workpieces 12 that come out of the cooling station in opposite positions and are ready to be stacked in the unloading station. FIGS. 7E-7F illustrate the upper rollers 402 that are preferably urethane rubber coated rollers which are free spinning and adjustable. The lower rollers 404 are preferably motorized and have the internal shape of the workpiece 12 being manufactured.

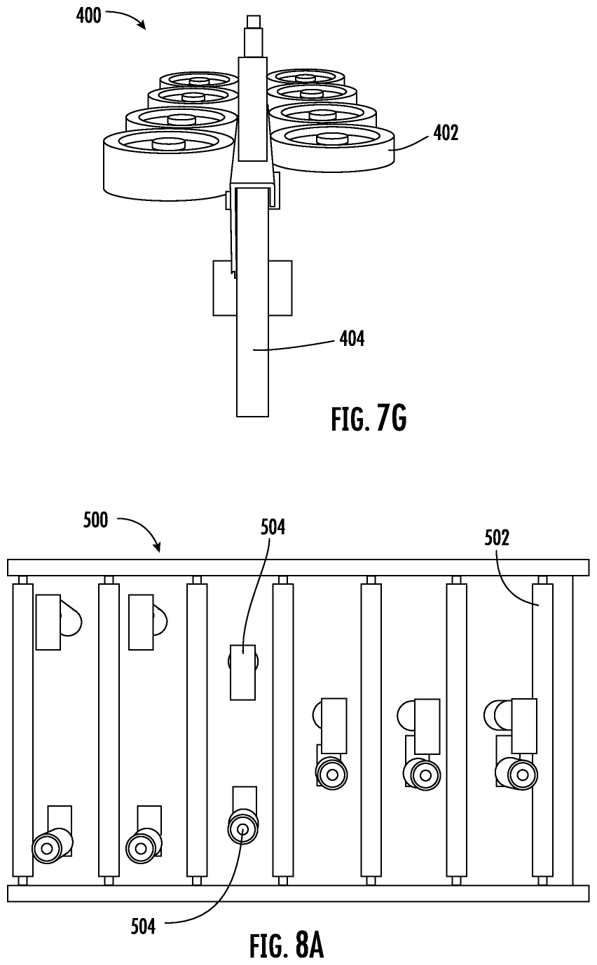

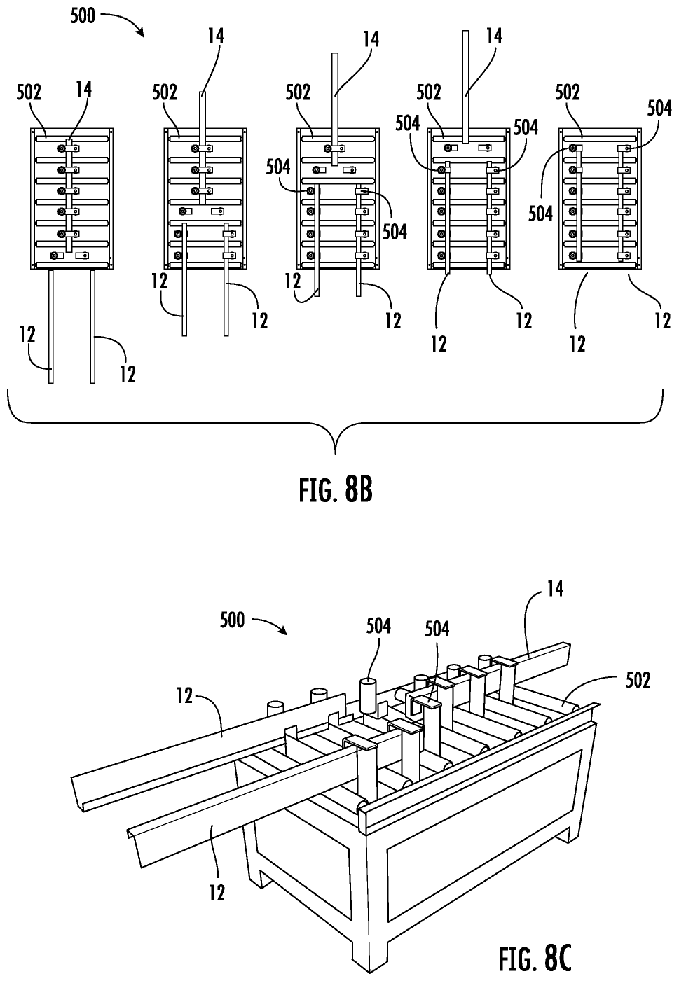

FIG. 8A is a top view of a first unloading station 500 which takes two workpieces 12 simultaneously that come out of the cooling station 400 and, using motorized carrier rollers 502, group the workpieces in the position in which they should be stacked on the pallet 16. FIG. 8B is a diagram illustrating workpiece positions on the first unloading station 500 with diagram 1 depicting two workpieces 12 separated by a space about to enter the station, and two workpieces that have been nested together 14. FIG. 8B diagram 2 depicts the two work pieces 12 partially captured by alignment supports on the table, and the two workpieces nested 14 together as they as they travel off the station. FIG. 8B diagram 3 depicts the two work pieces 12 partially captured by alignment supports 504 progressively moving across the table and, and the two workpieces nested together 14 as they as they travel off the station. FIG. 8B diagram 4 depicts the two workpieces 12 captured by alignment supports 504 on the table, and the two workpieces nested together 14 transferred off the table. FIG. 8B diagram 5 depicts the two workpieces 12 totally captured by alignment supports 504 on the table directly before the work pieces are nested.

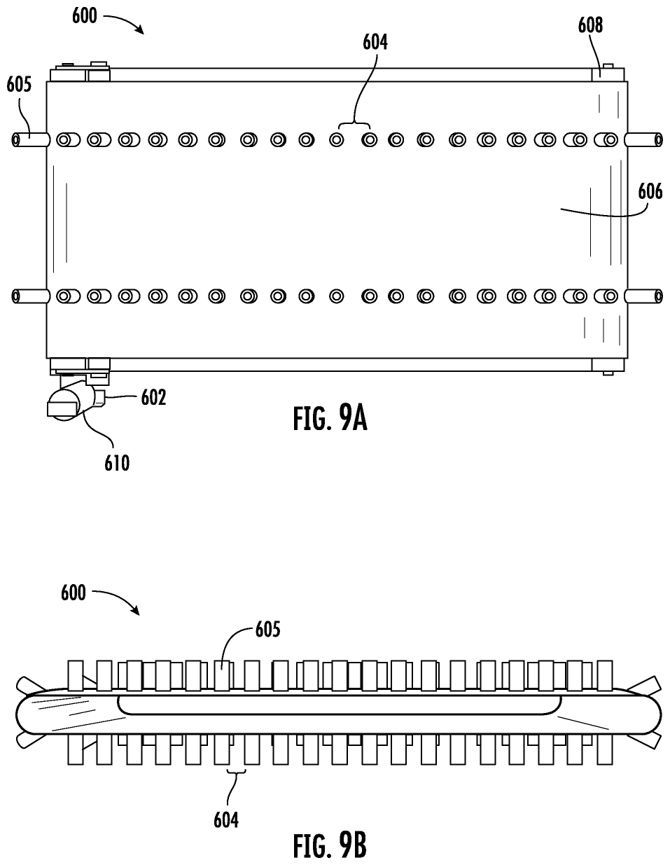

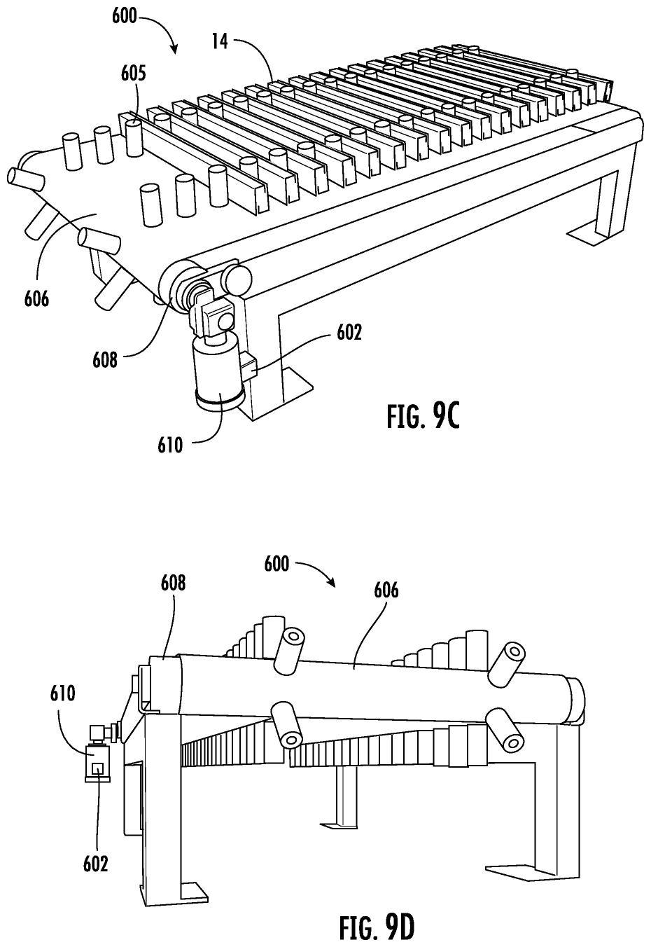

FIGS. 9A-9D illustrate the second unloading station 600 which employs sensors 602 to determine when a group of two workpieces 14 is in each of the slots 604 of a conveyor belt 606. The conveyor belt 606 moves the nested workpieces 14 from the first unloading station 500 for placement on a pallet 16. The vertical rollers 608 are positioned perpendicular to the conveyor belt 606 and are free spinning, namely they rotate only while receiving the workpiece 14. The roller 605 keeps the two nested workpieces 14 in the nested position. The conveyor belt 606 is indexed by a motor 610 which is activated and advances every time the sensor 602 reads that a two-piece pack is in its slot 604. When the workpieces 14 leave the conveyor belts 606, the conveyor belt 606 returns through the lower part of the system to be positioned again and receive more finished workpieces.

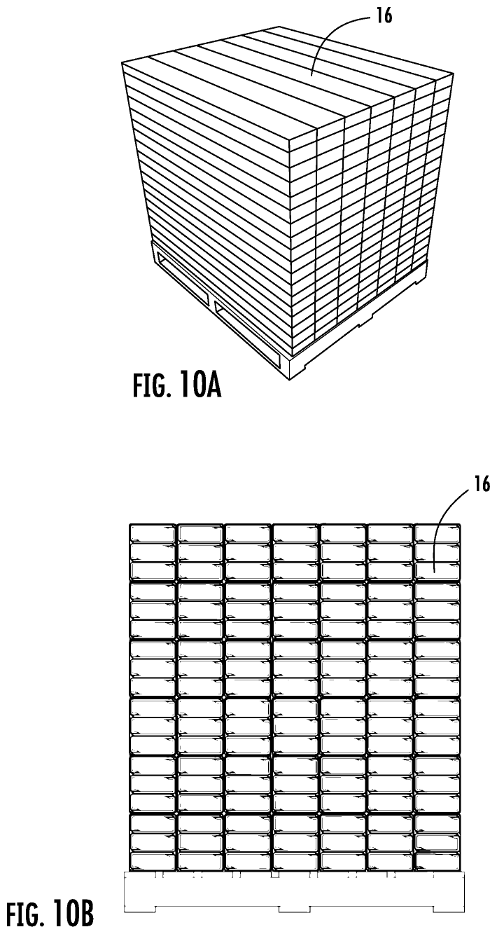

FIG. 10A is a perspective upper view of a pallet 16 layout with finished workpieces 14 nested and stacked. FIG. 10B is an end view of the pallet 16 layout to illustrate the overlapping. For example, a product of 5,000 pieces per day represents a total of 20 48×42 inch pallets. The total area of a production of 5,000 pieces per day, already palletized, would occupy an area of approximately 500 sq. ft. The pallets are not intended to be stacked.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein. The invention is readily adaptable to LVP, LVT, SPC, WPC or the like materials.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

The use of the word “a” or “an” when used in conjunction with the term “comprising” in the claims and/or the specification may mean “one,” but it is also consistent with the meaning of “one or more” or “at least one.” The use of the term “or” in the claims is used to mean “and/or” unless explicitly indicated to refer to alternatives only or the alternative are mutually exclusive, although the disclosure supports a definition that refers to only alternatives and “and/or.”

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements, possesses those one or more steps or elements, but is not limited to possessing only those one or more elements. Likewise, a step of a method or an element of a device that “comprises,” “has,” “includes” or “contains” one or more features, possesses those one or more features, but is not limited to possessing only those one or more features. Furthermore, a device or structure that is configured in a certain way is configured in at least that way, but may also be configured in ways that are not listed.

What is claimed is:

1. A composite flooring plank modification apparatus comprising:
an automatic loader having a plurality of pneumatic suction cups constructed and arranged to hold a composite flooring plank workpiece;
a motorized heating station coupled to said workpiece loader having an upper heat source and a lower heat source and motorized rollers to heat a portion of said workpiece to at least 90 degrees Centigrade;
a rotary positive and negative embossing station coupled to said motorized heating station having a plurality of rollers to exert pressure onto said workpiece to form said workpiece into a desired shape;
a motorized cooling station for receipt of said workpiece comprising a system of upper rollers and lower rollers with at least one fan to cool said workpiece, said upper rollers are adjustable and free spinning and said lower rollers are driven by a motor to transfer said workpiece at a required rate to maintain said workpiece in the desired shape;
a first unloading station having carrier rollers and a plurality of alignment supports constructed and arranged to move and position each said workpiece from said motorized cooling station and combine like workpieces together into a single nested workpiece, wherein said nested workpiece are grouped in a position to be stacked on a pallet;
a second unloading station having a conveyor belt with a plurality of vertical rollers positioned perpendicular to and disposed along said conveyor belt defining slots therebetween, said conveyor belt disposed between said first unloading station and said pallet;
wherein said automatic plank loader, said motorized heat station, said rotary positive and negative embossing station, said motorized cooling station, said first unloading station and said second unloading station are interconnected to fold said workpieces into stair noses and other trim elements.

2. The composite flooring plank modification apparatus according to claim 1, wherein each said workpieces are placed into said motorized feeder simultaneously.

3. The composite flooring plank modification apparatus according to claim 1, wherein said upper heat source is divided into four independent sections on each side of said motorized heat station and can be accessed by opening a plurality of top covers for maintenance and repair.

4. The composite flooring plank modification apparatus according to claim 1, wherein said motorized rollers feed each said workpiece at a rate of approximately 25 feet per minute.

5. The composite flooring plank modification apparatus according to claim 1, wherein the temperature of said upper heating source and said lower heating source is approximately 600 degrees F. (about 315 degrees C.) with a heating source diameter of ⅝ inches (about 16 mm).

6. The composite flooring plank modification apparatus according to claim 1, wherein said plurality of rollers of said rotary positive and negative embossing station are made of polyurethane material.

7. The composite flooring plank modification apparatus according to claim 1, wherein said upper rollers feed each said workpiece at 25 feet per minute.

8. The composite flooring plank modification apparatus according to claim 1, wherein said upper rollers are urethane rubber coated.

9. The composite flooring plank modification apparatus according to claim 1, wherein said lower rollers have the internal shape of each said workpiece.

10. The composite flooring plank modification apparatus according to claim 1 wherein said heating source lines are separated by thermal insulation.

11. The composite flooring plank modification apparatus according to claim 1 wherein each said workpiece is placed on a first side pallet with a printed part of the floor facing up and a second side pallet with the print facing down and independently place each said workpiece into a motorized feeder.

12. The composite flooring plank modification apparatus according to claim 1 including a handwheel associated with each said corresponding roller to modify the exerted pressure.

13. The composite flooring plank modification apparatus according to claim 1 wherein said second unloading station includes at least one sensor to determine when a group of workpieces are nested, wherein said conveyor belt is indexed by a motor which is activated and advances every time said sensor reads that said nested workpieces are in said slot.
